(19) United States
(12) Patent Application Publication
(10) Pub. No.: US 2018/0343895 A1
(43) Pub. Date: Dec. 6, 2018

(54) PROCESS FOR MANUFACTURING AN INJECTION MOLDED PET TREAT

(71) Applicant: Douglas Christopher Hepler, Rochester, NY (US)

(72) Inventor: Douglas Christopher Hepler, Rochester, NY (US)

(73) Assignee: Polyshot Corporation, West Henrietta, NY (US)

(21) Appl. No.: 15/613,348

(22) Filed: Jun. 5, 2017

(51) Int. Cl. A23K 40/20; A23K 20/147; A23K 50/45

(52) U.S. Cl. CPC A23K 40/20; A23K 50/40; A23K 50/45; A23K 20/147

(57) ABSTRACT

A process for manufacturing an injection molded pet treat in a single, continuous and sterile production line, is disclosed. The process comprises inputting raw material in a storage container of the injection molding machine. The raw materials are dispensed from the storage container to a hopper of the injection molding machine. The quantity of the raw material in the hopper is maintained to a preset threshold value for continuous flow in the production line. The raw material is heated at a predetermined temperature to a semi-liquid state in an injection unit of the injection molding machine. Further, the heated raw material is injected into a thinner and uniform wall thickness mold pet treat design, thereby enabling rapid cooling of the molded pet treat. The molded pet treat is ejected to the injection molding discharge area, and conveyed to a packaging unit for packing the final pet treat product.

### BACKGROUND OF THE INVENTION

### A. Technical Field

The present invention relates generally to a process for manufacturing pet treat, and, more particularly, to the process for manufacturing pet treat using an injection molding machine. Further, the present invention also relates to a process for manufacturing pet treat using a predetermined mold design and process parameters in a single, continuous, and sterile production line, thereby increases the production rate of the pet treat products.

### B. Description of Related Art

Generally, an edible pet treat is a polymeric composition with an expanded appearance like that of a food products. Pet treats are readily chewable so that a pet animal teeth could be penetrated to the treat. It would be characterized with required strength that it could eliminate the occurrence of choking in the pet animals. It could be produced by using several manufacturing processes, and could be made of various shapes and sizes.

Some of the proposed prior arts attempted to manufacture the pet treat using injection molding machine are, Reiser et al., U.S. Pat. App. No. 20150296837 discloses a method for making pet treat from a composition using the injection molding machine. The compositions are injection molded or extruded to produce a final pet chew or treat from the composition. In some preferred forms when injection molding is used, the supercritical fluid contacts the composition during the injection molding process. In some preferred injection molding processes, the composition is extruded prior to the injection molding process. In some forms, the supercritical fluid is added to the composition during the extrusion process and prior to the injection molding process. When the composition is extruded to produce the final pet chew product, the supercritical fluid contacts the composition during the extrusion process.

Lang et al., U.S. Pat. App. No. 2016183555 discloses a method for forming a digestible pet chew. The method includes combining ingredients comprising a leavening agent and an acid to form a mixture having about 16 to 32% moisture. The mixture is added to a barrel of an injection molding machine, and the mixture is plasticized with heat and pressure to form a plasticized material. The plasticized material is then injected into a chilled mold and cooled in the mold for a time sufficient to form a skin surrounding a center portion. The mold is then released to allow the center portion to expand to form a pet chew having an outer skin and an expanded center.

However, the existing process for manufacturing pet treats represents a huge challenge on producing pet treats in a single, continuous, and sterile production line without any waste, manual handling and contamination. Further, the existing process for manufacturing a pet treat is time-consuming, and the molds are designed with thick cross section, which facilitates longer molding cycles with slow cooling and ejecting process. In the existing molding process, the molded parts are transferred from the injection molding machine to bins or racks, permitting dry air to pass around the pet treat mold to reach the moisture level with water activity below 0.70 a_{w}. Henceforth, this existing process further requires additional curing, hardening, and separate packaging process, which is also a time-consuming (few more hours or even days), and expensive batch process.

Therefore, there is a need in the art for manufacturing an edible pet treat in a rapid production rate with required quality by an injection molding machine. There is also a need in the art for an automatic process to produce the injection molded pet treat product in a single, continuous, and sterile production line, which enables rapid production rate, and better outcomes for a user in reduced cost.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The invention disclosed herein addresses the above-mentioned need for a process for manufacturing pet treat using an injection molding machine. In an embodiment, the process of manufacturing the pet treat, comprising the steps of inputting or loading one or more raw materials in a storage container of an injection molding machine. In another embodiment, the raw materials are dispensed from the input storage container to hopper of the injection molding machine. The quantity of the raw material is maintained to a preset threshold value in the hopper of the injection molding machine for continual flow or process in the production line. In another embodiment, the raw material is heated at a predetermined temperature to a semi-liquid state in an injection unit or zone of the injection molding machine. Then, the heated raw material is injected into a thinner and uniform wall thickness mold pet treat design thereby enabling rapid cooling of the hot post molded pet treat. The process parameter maintained at the injection unit are: the predetermined temperature incorporated by barrel and hot runner zone temperature for the injection unit ranges from 210° F. to 280° F., the predetermined injection speed for the injection unit ranges from 1 in/s to 5 in/s, the injection unit further comprises injection screw recovery speed from 50 rpm to 140 rpm, the injection pressure is maintained between 700 PSI to 1700 PSI, and the predetermined temperature for the injection mold ranges from 50° F. to 110° F. Finally, the molded pet treat is ejected to the injection molding discharge area, and the ejected pet treat is conveyed by any known method of conveyance to a packaging unit thereby producing the packed pet treat product in a single, continuous, and sterile production line.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a process for manufacturing pet treat using injection molding machine in accordance with various embodiments of the invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The term “sterile” as used herein refers to any known or later developed a clean isolated path for any input or raw materials, and for prepackaged treats, wherein the input or raw materials could be in any form, for example, pellet or powder. Also, while the present disclosure is described in terms of exemplary embodiments, it should be appreciated those individual aspects of the present disclosure can be separately claimed.

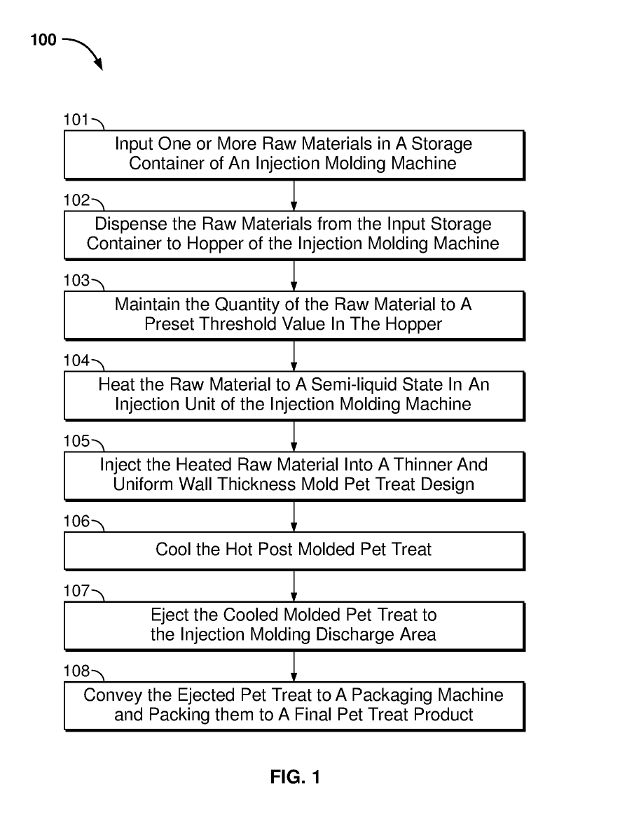

The present invention relates to a process for manufacturing an edible pet treat by an injection molding machine. Referring to FIG. 1, the process 100 of manufacturing the pet treat in step 101 comprises, inputting or loading one or more raw materials in a storage container of an injection molding machine. In step 102, the raw materials are dispensed from the input storage container to hopper of the injection molding machine. The quantity of the raw material is maintained to a preset threshold value in the hopper of the injection molding machine for continual flow or process in the production line in step 103. In another embodiment, the raw material is heated at a predetermined temperature to a semi-liquid state in an injection unit or zone of the injection molding machine, in step 104. In an embodiment, the pellet form of the raw material is converted into a hot injection moldable and semi-liquid form by the injection unit of the injection molding machine. In step 105, the heated raw material is injected into a thinner and uniform wall thickness mold pet treat design thereby enabling rapid cooling of the hot molded pet treat in step 106.

In an embodiment, the process parameters to be maintained at the above said steps are, the predetermined temperature incorporated by barrel and hot runner zone temperature for the injection unit ranges from 210° F. to 280° F., the predetermined injection speed for the injection unit ranges from 1 in/s to 5 in/s, the injection unit further comprises injection screw recovery speed from 50 rpm to 140 rpm, the injection pressure is maintained between 700 PSI to 1700 PSI, and the predetermined temperature for the injection mold ranges from 50° F. to 110° F. In step 107, the molded pet treat is ejected to the injection molding discharge area, and the ejected pet treat is conveyed by any known method of conveyance to a packaging unit thereby producing the packed pet treat product in a single, continuous, and sterile production line in step 108.

In one embodiment, the input raw materials include but are not limited to particular form such as pellet form, powdered form, slurry form, or a combination form thereof. In some embodiments, the raw materials include but are not limited to flour, starch, glycerin, protein, gelatin, cellulose base, dental cleaning agent, flavoring agent, or nutrient agent. In one embodiment, the pellet form of the raw material comprises water activity ranges from 0.55 a_{w} to 0.70 a_{w} with moisture content ranges from 5% to 20%. In another embodiment, the raw material from the input storage container is dispensed via a vacuum loader, or a conveyor to the hopper of the injection molding machine. In some embodiments, the raw material from the input storage container is dispensed via an auger conveyor to the hopper of the injection molding machine.

In one embodiment, the quantity of the raw material is maintained to a preset threshold value via a communication signal. In one embodiment, the communication signal is a sensor incorporated communication signal. In one embodiment, the communication signal from the hopper is communicated to operate the loader, or conveyor, if the quantity of the raw material is lower than the set threshold value in the hopper of the injection molding machine.

In one embodiment of the said process 100, the communication signal from the hopper is communicated to terminate the operation of the loader, or conveyor, if the quantity of the raw material is equal to the set threshold value in the hopper of the injection molding machine. In another embodiment, the injection unit comprises a hot barrel with a reciprocating feed or plasticizing screw. Through the rotation and reciprocation of the screw, the pellet form of raw materials are heated and cured into a hot semi-liquid state. In some embodiments, the raw material passing from the hopper to the injection unit is inspected via a series of magnets to remove metal contamination. In another embodiment, the pellet form of raw materials are fed from the hopper through a series of magnets for removing metal contamination into an injection unit. In an embodiment, the semi-liquid state is injected into the mold and cooled at predetermined time and temperature inside the mold for ejection. In some embodiments, the injection mold pet treat design comprises a cavity ranges from 1 to 240 cavities, or 1 to 240 parts each cycle are produced.

In one embodiment, the ejected finished molded pet treat is transferred to the packaging unit via a conveyance device. In some embodiments, the packaging unit could be in the form of bagging or packing pet treats into pouches, flow wrapping, or any other known type of packing forms. In another embodiment, the packaging unit introduces a gas to inhibit spoilage of the molded pet treat. In another embodiment, the set time for cooling ejected molded pet treat from the injection unit to the packaging unit is adjusted by length or speed of the conveyance device. The time consumption for ejected molded treat from the injection mold to the packing unit could be varied by conveyor length or conveyor speed. Extending the time or slowing down the conveyor speed increases the cooling time, allowing additional cooling time for the pet treat. If the hot molded pet treats are not adequately cooled before packing, forms a visible moisture on the molded treat and enhances the propagation of pathogens. As the hot molded pet treats cools during the conveying process, allowing the pet treat to be bagged/packed safely, and directly from the molding process. This allows the pet treats to be bagged with the water activity between 0.55 a_{w} and 0.70 a_{w}, thereby eliminating additional curing or hardening process and/or time.

In one embodiment, the packed pet treat product is inspected via a metal detector for identifying metal contamination and examining the set quality parameter for the pet treat product. After packaging the finished bagged or flow wrapped pet treats, the packed pet treats are automatically sent via a metal detector to check for any metal contamination and additional post packaging inspection like checking weight, etc.

The main feature of the present invention is the implementation of thinner, consistent mold treat design, which is between 1.5 mm to 5 mm is maintained thereby allowing rapid cooling of the mold and requires shorter molding cycles. Moreover, the said mold treat design could dissipate heat and moisture quickly allowing the packaging unit to safely pack the finished pet treat rapidly. The raw material used for manufacturing pet treat aids in good dental hygiene, flavors, added vitamins and other minerals, nutrients, etc. Further, the advantage of the said process 100 for manufacturing pet treat products using an injection molding machine includes, a single continuous production line without any waste, manual handling, additional post molding process such as curing and/or hardening, and any intervention of an operator or a worker.

One of the main key feature of the invention is the process 100 of producing injected molded pet treat product using completely isolated raw material or finished treat production flow line/path. The process 100 is provided with an ability to produce molded treats without any exposure to human hand or other contamination in the entire material flow path from raw materials such as pellets to the finished treats. Thus, the present invention relating to the said process 100 defines the term for sterile flow path or sterile production line for producing the pet treat products. The process 100 further allows the placement of the injection molding machine and equipment such as loader, conveyor and bagger/packaging unit in a clean and sterile manufacturing environment producing clean and sterile pet treats free from potential contamination, for example, salmonella, which could be introduced by handling the treat with non-sanitized hands etc. Hence, the process 100 also reduces the maintenance cost due to the placement of the entire injection molding machine. Using the bagger/packager, the pet treats could be sealed in a package for example, an air tight polymer package, etc. for safe and convenient handle by a user.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

what is claimed is:

1. A process for manufacturing an edible pet treat by an injection molding machine, comprising the steps of:
inputting one or more raw materials in a storage container of an injection molding machine;
dispensing the raw materials from the input storage container to hopper of the injection molding machine;
maintaining the quantity of the raw material to a preset threshold value in the hopper of the injection molding machine;
heating the raw material at a predetermined temperature to a semi-liquid state in an injection unit of the injection molding machine;
injecting the heated raw material into a thinner and uniform wall thickness mold pet treat design thereby enabling rapid cooling of the hot post molded pet treat,
wherein the predetermined temperature by incorporating barrel and hot runner zone temperature for the injection unit ranges from 210° F. to 280° F., the predetermined injection speed for the injection unit ranges from 1 in/s to 5 in/s, the injection unit further comprises injection screw recovery speed from 50 rpm to 140 rpm, the injection pressure is maintained between 700 PSI to 1700 PSI, and the predetermined temperature for the injection mold ranges from 50° F. to 110° F.;
ejecting the molded pet treat to the injection molding discharge area, and conveying the ejected pet treat via a conveyance device to a packaging unit thereby producing the packed pet treat product in a single, continuous, and sterile production line.

2. The process of claim 1, wherein the input raw material is one of pellet form, powdered form, slurry form, or a combination form thereof.

3. The process of claim 1, wherein the raw material is one of flour, starch, glycerin, protein, gelatin, cellulose base, dental cleaning agent, flavoring agent, or nutrient agent.

4. The process of claim 1, wherein the raw material being the pellet form comprises water activity ranges from 0.55 a_{w} to 0.70 a_{w} with moisture content ranges from 5% to 20%.

5. The process of claim 1, wherein the raw material from the input storage container is dispensed via a vacuum loader, or a conveyor to the hopper of the injection molding machine.

6. The process of claim 1, wherein the raw material from the input storage container is dispensed via an auger conveyor to the hopper of the injection molding machine.

7. The process of claim 1, wherein the quantity of the raw material is maintained to a preset threshold value via a communication signal.

8. The process of claim 1, wherein the quantity of the raw material is maintained to a preset threshold value via a communication signal.

9. The process of claim 8, wherein the communication signal is a sensor incorporated communication signal.

10. The process of claim 8, wherein the communication signal from the hopper is communicated to operate the loader, or conveyor, if the quantity of the raw material is lower than the set threshold value in the hopper of the injection molding machine.

11. The process of claim 8, wherein the communication signal from the hopper is communicated to terminate the operation of the loader, or conveyor, if the quantity of the raw material is equal to the set threshold value in the hopper of the injection molding machine.

12. The process of claim 1, wherein the raw material passing from the hopper to the injection unit is inspected via a series of magnets to remove metal contamination.

13. The process of claim 1, wherein the injection unit comprises a hot barrel with a reciprocating feed or plasticizing screw.

14. The process of claim 1, wherein the semi-liquid state is injected into the mold and cooled at predetermined time and temperature inside the mold for ejection.

15. The process of claim 1, wherein the injection mold pet treat design comprises a cavity ranges from 1 to 240 cavities.

16. The process of claim 1, wherein the ejected finished molded pet treat is transferred to the packaging unit via a conveyance device.

17. The process of claim 1, wherein the packaging unit introduces a gas to inhibit spoilage of the molded pet treat.

18. The process of claim 1, wherein the set time for cooling ejected molded pet treat from the injection unit to the packaging unit is adjusted by length or speed of the conveyance device.

19. The process of claim 1, wherein the packed pet treat product is inspected via a metal detector for identifying metal contamination and examining set quality parameter for the finished pet treat product.
